(19) United States
(12) Patent Application Publication
(10) Pub. No.: US 2010/0084236 A1
(43) Pub. Date: Apr. 8, 2010

(54) POWER ADAPTOR WITH SINGLE-PULL CABLE ROLL-UP

(76) Inventor: HSIEN-LIN YANG, Taipei City (TW)

Correspondence Address: LEONG C LEI, PMB # 1008, 1867 YGNACIO VALLEY ROAD, WALNUT CREEK, CA, 94598, US

(21) Appl. No.: 12/247,219

(22) Filed: Oct. 7, 2008

(51) Int. Cl. H02G 11/02; H01R 13/72; B65H 75/34

(52) U.S. Cl. 191/12.4; 242/371; 439/501

(57) ABSTRACT

A power adaptor includes a top cover mounted to a bottom cover to interpose therebetween a rotary cable winding hub defined between top and bottom frames and forming a circumferential slot for winding up a cable therein. The top frame forms a space receiving therein a roll-up spring that provides a biasing force to the cable winding hub for winding up the cable. The bottom frame forms a recess fit over a raised fixing base extending from the bottom cover and forming multiple tracks each forming a stop terminal for properly retaining the cable winding hub for each turn of rotation of the cable winding hub in extending the cable.

### TECHNICAL FIELD OF THE INVENTION

The present invention generally relates to a power adaptor with single-pull cable roll-up that aims to improve and make a breakthrough of the conventional power adaptor that may lead to problems of cable entangling and being hard to carry and store due to excessive length of a fixed length cable by providing a construction that allows roll-up of the cable of the power adaptor, and in particular to a construction that allows for unidirectional roll-up, multiple stages of positioning, and cooperation between pulling/winding up cable and inside conductors to allow, with cable rolled up and internal conduction of electrical power established, electrical power can be converted and directly output through a charge adaptation plug arranged at a terminal of the cable, thereby completely innovating the charge cable of the conventional power adaptor and providing a power adaptor having a charge cable that has a configuration allowing for unidirectional extension, winding up, positioning, and concealing.

In accordance with the present invention, the power adaptor is comprised of two portions, one being a unidirectional and multiple-staged cable extension/winding up structure, and the other being the arrangement of conductors for the cable.

The unidirectional and multiple-staged cable extension/winding up structure allows a single charge cable to determine a length of extension and/or roll-up in accordance with the number of turns of rotation of a circumferential slot of a cable winding hub and the charge cable has a leading end extending into the cable winding hub to reach a bottom frame for connection with positive-electrode and negative-electrode conductor plates fixed therein with the positive-electrode and negative-electrode conductor plates corresponding to positive-electrode and negative-electrode rings formed on a surface of a circuit board to form constant-pressurization engagements therebetween, so as to output the electrical power converted by the power adaptor through the charge cable. The cable winding hub has a top frame that forms an internal space for receiving the winding of a roll-up spring therein for housing and protection, which provides an opposite-direction resisting force to the charge cable to provide a mechanical power for re-winding and returning of the charge cable.

When the power adaptor is operated to extend or wind up the charge cable, the cable winding hub received therein is caused to rotate in a forward or backward direction for setting the roll-up spring inside the top frame in a released or tight roll-up condition with the positive-electrode and negative-electrode conductor plates arranged in the bottom frame of the cable winding hub being positioned in correspondence with positive-electrode and negative-electrode rings that are located thereunder by means of flexible resiliency to ensure constant-pressurization engagement therebetween without being affected by the rotation of the cable winding hub so as to ensure power conduction and transmission through the charge cable.

The cable winding hub of the present invention uses the spring force of the roll-up spring as a main power for extending and winding up the charge cable, and positioning that can be realized in the mechanism means efficiently effected positioning mechanism when the charge cable is extended, which provides not only the capability of “one-time fast rewinding and returning”, but also a stepwise “positioning” function for further extension of the charge cable after the cable has been positioned. Such a structure is realized through a track structure formed in a surface of a recess defined in the bottom frame of the cable winding hub that opposes a fixing base of the bottom cover of the power adaptor and a positioning bead that provides an “enclosed and limiting” configuration that is concealed and internally and stably arranged to completely overcome problems of tracks that forces disengagement of the positioning bead in the course of high speed rotation of the cable winding hub due to gaps.

The arrangement of the conductors of the charge cable is realized by engagement of the positive-electrode and negative-electrode conductor plates with a circuit board, where a leading end of the charge cable extends downward to get into the internal space of the bottom frame of the cable winding hub and fixed by a charge cable fixing slot with the positive and negative electrodes of the charge cable respectively connected to positive-electrode and negative-electrode rings that are on different concentric circles to provide connection for power conduction.

The circuit board carries an electronic assembly that is necessary for power conversion and also forms, frontward, a fitting hole for fitting and mounting to the fixing base of the bottom cover of the power adaptor and the circuit board forms positive-electrode and negative-electrode (inner and outer) rings that are for pressurized engagement with the positive-electrode and negative-electrode conductor plates that are set on different concentric circles for output of electrical power that has been subjected to power conversion at the charge adaptation plug through the conductor arrangement of the charge cable.

### DESCRIPTION OF THE PRIOR ART

In the technical field of power adaptors, most efforts in development and research are put in the problems associated with conversion of voltage and current and charging for the attempt to provide high passing rate of products. However, no much novelty has been found in association with the mechanical construction thereof. Almost all the novelties in this field are made for conversion or transformation of current and voltage for improving charging performance. Consequently, various shortcomings are found in the mechanical construction.

Various and versatile electronic devices are so numerous in the market that it is hard the really know the number. Examples are mobile phones, digital cameras, notebook computers, personal digital assistants (PDAs), all being familiar to the general consumers. The target invention made in the present application is a power adaptor that functions to effect conversion of power for the electronic products. Although the various electronic devices are under the pressures of continuous improvement and miniaturization, the power adaptor that supplies electrical power in proper form to the electronic devices does not change much and maintains the old-fashion configuration of hanging on a long and fixed length charge cable extending therefrom.

A conventional power adaptor (A1) comprises a charge cable (A2) that is long and has a fixed length, as shown in FIG. 7 of the attached drawings. A known solution to overcome the problem of over-length of the cable (A2) is to fold and bond the multiple folds of the cable (A2) together. This way, however, does not make the outside appearance organized and beautiful and may lead to entangling of the cable. An even severer problem is associated with safety for the folding of the cable may eventually lead to damage of the cable after a long term use. Thus, the present invention aims to provide a solution to the above problems.

### SUMMARY OF THE INVENTION

In view of the above, the present invention provides a power adaptor with single-pull cable roll-up, comprising, in construction thereof, a top cover, a roll-up spring, a rotary cable winding hub, a positioning bead, a charge cable, a charge adaptation plug, a circuit board, an electronic assembly, and a bottom cover, wherein the roll-up spring is wound up and received in an internal space defined in a top frame of the cable winding hub and provides an opposite-direction resisting force to the charge cable wound around a circumferential slot of the cable winding hub so as to provide a mechanical power source for extending or rewinding the charge cable. Further, the roll-up spring has an internal central terminal that is fit in a slit defined in a central axle extending from the screen and an external terminal forming a hook fit in and fixed to a circumferential-wall notch of the cable winding hub, whereby the roll-up spring is selectively set in a tight wind-up condition or a released condition depending upon the rotation of the cable winding hub in either the forward direction or the backward direction.

The circumferential slot of the cable winding hub functions to wind up the charge cable in such a way that an internal end of the charge cable initially extends into an internal space formed in the bottom frame of the cable winding hub and is fixed by a charge cable fixing slot. The positive and negative electrodes of the charge cable are then respectively connected to positive-electrode and negative-electrode conductor plates to form connection for conduction of power. Next, the positive-electrode and negative-electrode conductor plates are set in locations that are at different concentric circles to provide a relative distance therebetween. Thus, the circuit board may set positive-electrode and negative-electrode (inner and outer) rings to correspond to the positive-electrode and negative-electrode conductor plates to form respective constant-pressurization engagements therebetween.

Based on the principle and construction of the present invention, the power adaptor of the present invention provides a positioning mechanism that is realized with a track structure formed in a surface of a recess of the cable winding hub bottom frame that opposes a fixing base of a bottom cover and a positioning bead to form an “enclosed and limiting” configuration. Further, based on the extension and rewinding of the charge cable, the cable winding hub is driven to do forward and backward rotation, which simultaneously drives the positioning bead to alternately carry out releasing and retention.

The foregoing objective and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a power adaptor constructed in accordance with a preferred embodiment of the present invention.

FIG. 2 is an exploded view of the power adaptor of the present invention.

FIG. 3 is a perspective view of a rotary cable winding hub of the present invention set in a reversed condition.

FIG. 4 is a plan view of the cable winding hub of the present invention in the reversed condition.

FIG. 5 is a cross-sectional view of the power adaptor of the present invention.

FIG. 6 is a perspective view illustrating an application of the power adaptor of the present invention.

FIG. 7 is a perspective view illustrating a conventional power adaptor.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

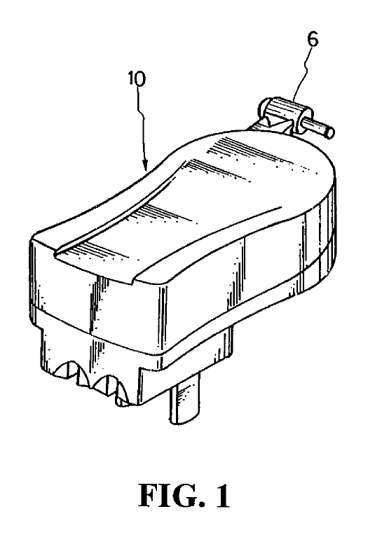

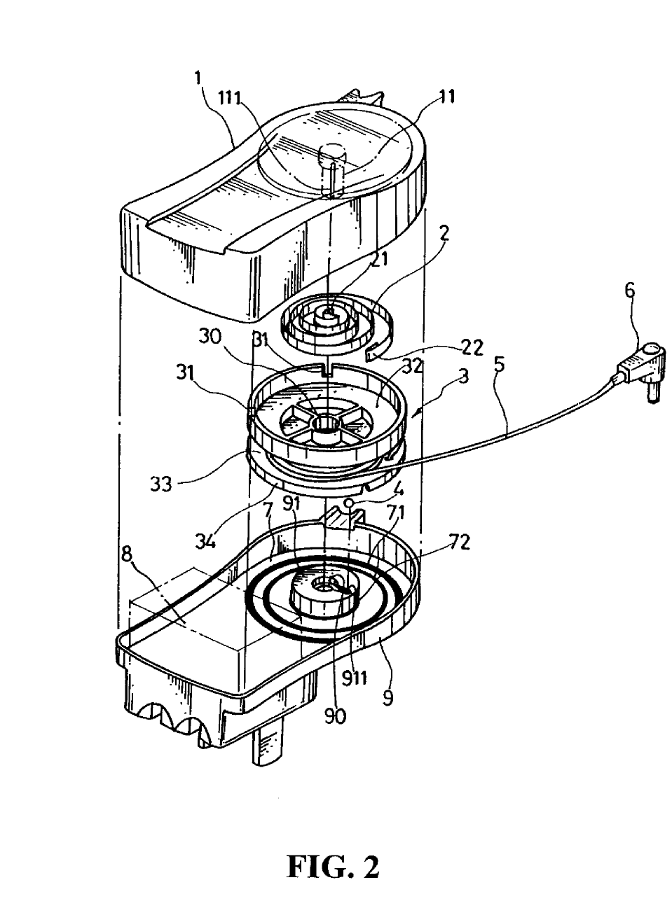

With reference to FIGS. 1 and 2, the present invention generally comprises, in construction thereof, a top cover 1, a roll-up spring 2, a rotary cable winding hub 3, a positioning bead 4, a charge cable 5, a charge adaptation plug 6, a circuit board 7, an electronic assembly 8, and a bottom cover 9. The roll-up spring 2 has an internal central terminal 21 that is fit in a slit 111 defined in a central axle 11 extending from the screen 1 and an external terminal forming a hook 22 fit in and fixed to a circumferential-wall notch 31 of the cable winding hub 3, whereby the roll-up spring 2 is selectively set in a tight wind-up condition or a released condition depending upon the rotation of the cable winding hub 3 in either the forward direction or the backward direction for providing mechanical power for rolling up and returning the charge cable 5.

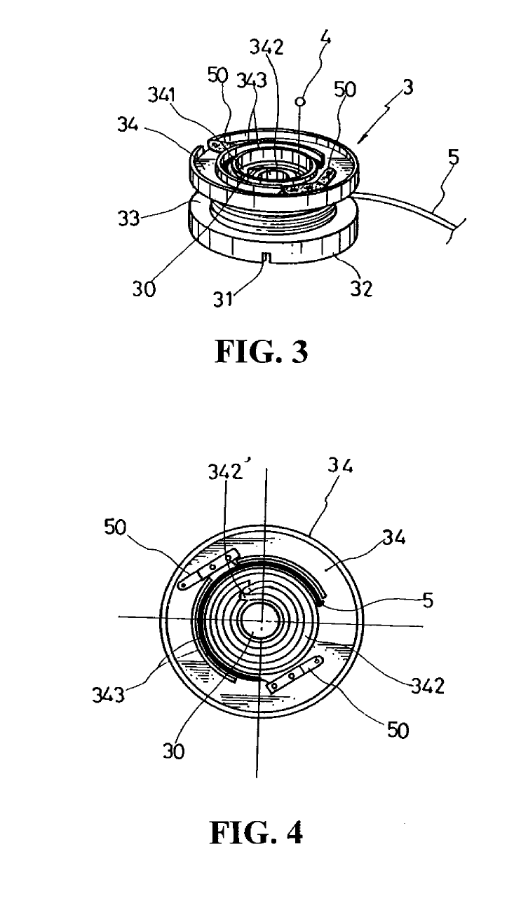

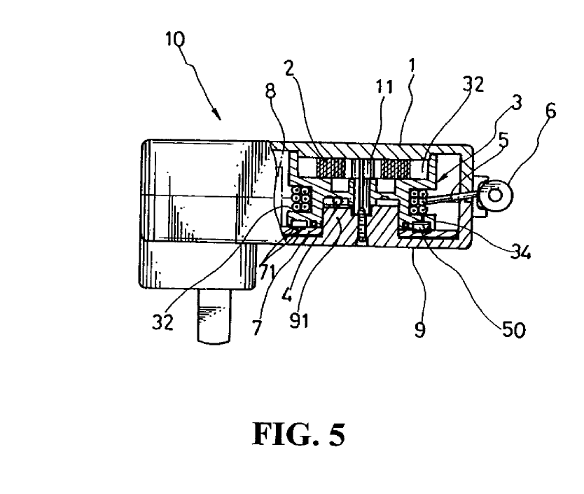

Also referring to FIGS. 3 and 5, the cable winding hub 3 is comprised of a top frame 32, a circumferential slot 33, and a bottom frame 34. The cable winding hub top frame 32 forms an internal space for winding up and releasing the roll-up spring 2 therein. The circumferential slot 33 is defined between the top frame 32 and the bottom frame 34 that provides a space for winding up the charge cable 5 therein. The bottom frame 34 forms an internal space that receives therein positive-electrode and negative-electrode conductor plates 50 and the cable winding hub 34 further defines a recess 341 having a surface forming a track structure 342 corresponding to a fixing base 91 of the bottom cover 9, whereby the positioning bead 4 that is arranged between the track structure 342 and the fixing base 91 shows an “enclosed and limiting” configuration.

Next, the central axle 11 extending from the top cover penetrates through a central bore 30 of the cable winding hub and is further fit into a fixing hole 90 defined in the fixing base 91. In this way, the central axle 11 of the top cover can be more stably supported and the cable winding hub 3 may be supported by the central axle 11 to carry out the forward and backward rotation. Further, the track structure 342 that is formed in the bottom frame recess 341 is of a multiple track arrangement, each track having a stop end 342′. The positioning bead 4 is set corresponding to a limiting groove 911 defined in a surface of the fixing base 91 so that the positioning bead 4 is only allowed to do reciprocal motion along the limiting groove 911. Thus, each time when the charge cable 5 is pulled to cause the cable winding hub 3 make rotation of a turn, the stop end 342′ and the limiting groove 911 cooperate with each other to induce a one-time positioning mechanism. When the charge cable 5 extends or rewinds in excess of an extent that the current positioning mechanism is allowed to operate for current turn, then a new positioning mechanism may be formed for the next turn, whereby the charge cable 5 of the power adaptor 10 is provided with convenience of multiple-staged extension/rewinding and positioning.

Also referring to FIG. 4, the charge cable 5 within the circumferential slot 33 of the cable winding hub 3 is set in such a way that an internal end of the charge cable 5 initially extends into the internal space formed by the bottom frame 34 of the cable winding hub 3 and is fixed by a dual-ring charge cable fixing slot 343 formed in the bottom frame 34. The positive and negative electrodes of the charge cable 5 are then respectively connected to the positive-electrode and negative-electrode conductor plates 50 that are fixed in position in advance to form connection for conduction of power. Next, since the positive-electrode and negative-electrode conductor plates 50 are set in locations that are at different concentric circles. Thus, to correspond to the circuit board 7, the positive-electrode and negative-electrode conductor plates 50 are set to respectively oppose positive-electrode and negative-electrode (inner and outer) rings 71 so that the positive-electrode and negative-electrode conductor plates 50 form respective constant-pressurization engagements, whereby the extension and/or rewinding of the charge cable 5 following the rotation of the cable winding hub 3 is not affected to ensure constant ON conduction of power supply.

Returning back to FIG. 2 and also referring to FIG. 5, the circuit board 7 carries on one side portion thereof the electronic assembly 8 that is necessary for power adaptation and forms a fitting bore 72 on an opposite side portion therefore for fitting over and mounting to the fixing base 91 of the power adaptor bottom cover 9 with the positive-electrode and negative-electrode (inner and outer) rings forming respective constant-pressurization engagements with the positive-electrode and negative-electrode conductor plates 50 of the cable winding hub bottom frame 34. Thus, the power that has been subjected to conversion can be supplied through the charge cable and the charge adaptation plug 6 arranged at the terminal of the charge cable when the charge cable 5 is either pulled outward or rewound to roll up.

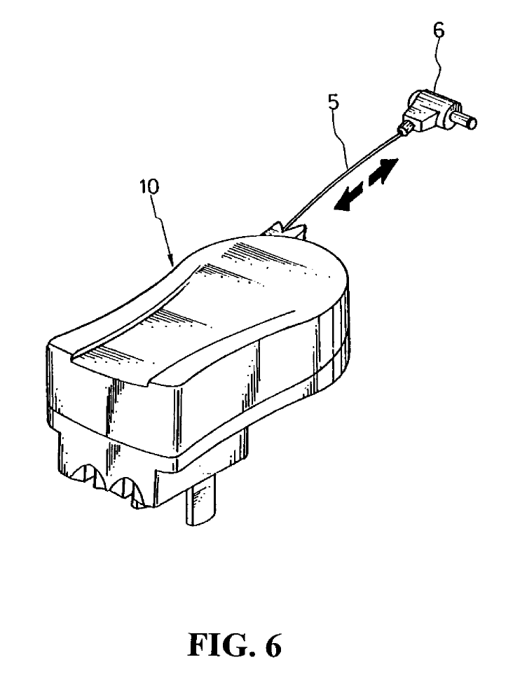

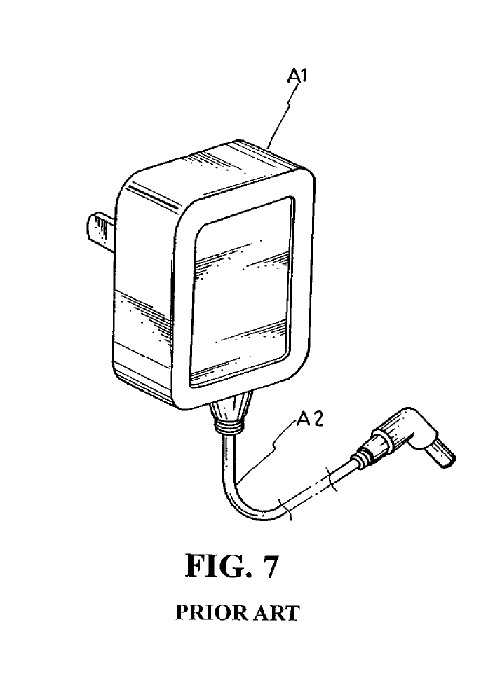

Last, as shown in FIG. 6, in accordance with the present invention, the charge cable 5 is concealed inside the power adaptor 10 and by pulling the charge cable 5 outward, extension to and connection with an electrical appliance for charging can be realized. Also, for each turn that the charge cable 5 is pulled, a corresponding positioning mechanism is induced. Further, in the course of extending the charge cable 5, it is possible to realize precise positioning control according to a desired length for the charge cable 5, whereby the power adaptor no longer hangs on a fixed length charge cable 5.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A power adaptor comprising a top cover, a roll-up spring, a rotary cable winding hub, a positioning bead, a charge cable, a charge adaptation plug, a circuit board, an electronic assembly, and a bottom cover, wherein:
the top cover forms an extended central axle penetrating through a central bore defined in the cable winding hub to be fit into a fixing hoe defined in a fixing base of the bottom cover, the central axle forming a slit in which an internal central terminal of the roll-up spring is fit and fixed;
the roll-up spring is received in an internal space formed in a top frame of the cable winding hub and has the internal central terminal fit in the slit defined in the top cover central axle and an external terminal forming a hook fit in and fixed to a circumferential-wall notch of the cable winding hub, so that the roll-up spring is selectively set in a tight wind-up condition or a released condition according to the rotation of the cable winding hub in either the forward direction or the backward direction for providing mechanical power for rolling up and returning the charge cable;
the cable winding hub forms the central bore for receiving the top cover central axle penetrating therethrough and the cable winding hub comprises a top frame, a circumferential slot, and a bottom frame, in which the top frame forms the internal space for receiving the roll-up spring therein, the circumferential slot is defined between the top frame and the bottom frame that provides a space for winding up the charge cable therein, and the bottom frame forms an internal space that receives therein positive-electrode and negative-electrode conductor plates and further forms a dual-ring charge cable fixing slot, the bottom frame defining a recess having a surface forming a track structure of a multiple track arrangement, the multiple tracks having a stop end, for corresponding to a limiting groove defined in the fixing base of the bottom cover and the positioning bead to form an “enclosed and limiting” configuration;
the positioning bead is set between the track structure defined in the surface of the recess of the bottom frame of the cable winding hub and the limiting groove defined in a surface of the fixing base of the bottom cover so that the positioning bead is only allowed to do reciprocal motion along the limiting groove;
the charge cable is wound around the circumferential slot of the cable winding hub and has a terminal forming the charge adaptation plug, an internal end of the charge cable initially extending into the internal space formed by the bottom frame of the cable winding hub and fixed by the dual-ring charge cable fixing slot formed in the bottom frame, positive and negative electrodes of the charge cable being respectively connected to the positive-electrode and negative-electrode conductor plates that are fixed in position in advance and set in locations at different concentric circles to form connection for conduction of power;
the charge adaptation plug is formed at the terminal of the charge cable;
the circuit board carries on one side portion thereof the electronic assembly and forms a fitting bore on an opposite side portion therefore for fitting over and mounting to the fixing base of the power adaptor bottom cover and having positive-electrode and negative-electrode rings set in correspondence to the positive-electrode and negative-electrode conductor plates of the cable winding hub bottom frame for forming respective constant-pressurization engagements therewith;
and the bottom cover forms the fixing base to be fit over and fixed to the circuit board, the fixing base allowing the recess of the bottom frame of the cable winding hub to fit thereon and has a surface forming the limiting groove, and also forms a fixing hole receiving the central axle of the top cover to fit therein.
